(19) United States
(12) Patent Application Publication
(10) Pub. No.: US 2026/0130820 A1
(43) Pub. Date: May 14, 2026

(54) APPARATUS AND SYSTEMS FOR OPTIMIZING NITRIC OXIDE PRODUCTION AND CONSUMPTION BY SUBJECTS

(71) Applicant: Joel S. Faden, Rockville, MD (US)

(72) Inventor: Joel S. Faden, Rockville, MD (US)

(21) Appl. No.: 19/385,266

(22) Filed: Nov. 11, 2025

Related U.S. Application Data
(60) Provisional application No. 63/719,057, filed on Nov. 11, 2024.
(60) Provisional application No. 63/735,269, filed on Dec. 17, 2024.

(51) Int. Cl. A61H 23/02

(52) U.S. Cl. CPC A61H 23/0236; A61H 2201/0192; A61H 2201/1607; A61H 2205/023

(57) ABSTRACT

Apparatus and systems for optimizing the production and consumption of nitric oxide by a subject, while facilitating efficient breathing to sustain the subject's regular activity levels, are provided. The apparatus may include a first portion configured for airtight deployment over a subject's nose, or within a subject's nostrils, and a second portion configured for airtight deployment over the subject's mouth. The first portion may include a valve configured to, during operation, pass air from an ambient environment therethrough and into the first portion, and prevent air within the first portion from being passed therethrough to exit the first portion. The second portion may include a valve configured to, during operation, prevent air from being passed therethrough to enter into the second portion, and pass air from within the second portion therethrough and out into the ambient environment. The first and second portions are hermetically separate from each other.

### RELATED APPLICATIONS

This application claims priority to U.S. Provisional Patent Application No. 63/719,057, filed on Nov. 11, 2024, and also claims priority to U.S. Provisional Patent Application No. 63/735,269, filed on Dec. 17, 2024, the entireties of which are herein incorporated by reference.

### FIELD

The present disclosure generally relates to a nose and mouth covering configured to optimize the production and consumption of nitric oxide by a subject (e.g., a human).

### BACKGROUND

The internal production of nitric oxide provides many health benefits. Nitric oxide is produced primarily in the paranasal sinuses, which are connected to the nasal cavity, meaning the nose is considered a major site of nitric oxide production in the body from breathing in air through the nose (including nitrogen and oxygen molecules in such air); the epithelial cells within the sinuses are the main source of this gas. Humming greatly increases nasal nitric oxide production and levels.

When one breathes in air through their nose, the nitric oxide produced in the sinuses is carried with the air and can be detected in exhaled breath. It would be beneficial to maximize the amount of nitric oxide produced and absorbed by the body while facilitating efficient breathing to sustain regular activity levels.

### SUMMARY

Presented herein are apparatuses, systems, and methods for optimizing nitric oxide production and consumption by a subject (e.g., a human).

In some embodiments, an apparatus for optimizing nitric oxide production and consumption by a subject is provided, comprising a first portion configured for airtight deployment over a nose, or within the nostrils of a nose, of a subject. The first portion may comprise a valve configured to, during operation, pass air from an ambient environment therethrough and into the first portion, and prevent air within the first portion from being passed therethrough to exit the first portion. The apparatus may further comprise a second portion configured for airtight deployment over a mouth of a subject, the second portion comprising a valve configured to, during operation, prevent air from being passed therethrough to enter into the second portion, and pass air from within the second portion therethrough and out into the ambient environment. In this apparatus, the first portion and the second portion may be hermetically separate.

In some embodiments, another apparatus for optimizing nitric oxide production and consumption by a subject is provided, comprising a mask configured for deployment over a nose and a mouth of a subject. The mask may comprise a first mask portion configured for airtight deployment over the nose of the subject. The first mask portion may comprise a valve configured to, during operation, pass air from an ambient environment therethrough and into the first mask portion, and prevent air within the first mask portion from being passed therethrough to exit the first mask portion. The first mask portion may additionally comprise a seal configured to prevent air from entering or exiting the first mask portion except through the first mask portion valve. The apparatus may further comprise a second mask portion configured for airtight deployment over the mouth of the subject. The second mask portion may comprise a valve configured to, during operation, prevent air from being passed therethrough to enter into the second mask portion, and pass air from within the second mask portion therethrough and out into the ambient environment. The second mask portion may additionally comprise a seal configured to prevent air from entering or exiting the second mask portion except through the second mask portion valve. In this apparatus, the first mask portion and the second mask portion may be hermetically separate.

In some embodiments, a system for optimizing nitric oxide production and consumption by a subject is provided, comprising a plurality of nose plugs, wherein at least a portion of each nose plug is configured for airtight deployment within a respective nostril of the nose of the subject. Each nose plug may comprise a respective valve configured to, during operation, pass air from an ambient environment therethrough and into the respective nose plug within the respective nostril of the nose of the subject, and prevent air within the respective nostril of the nose of the subject from being passed therethrough to exit the respective nose plug. The system may further comprise a mouthpiece configured for airtight deployment over the mouth of the subject, the mouthpiece comprises a valve configured to, during operation, prevent air from being passed therethrough to enter into the mouthpiece and pass air from within the mouth of the subject therethrough and out into the ambient environment. The system may further comprise a seal configured to prevent air from entering or exiting the mouthpiece except through the mouthpiece valve, wherein the plurality of nose plugs and the mouthpiece are hermetically separate.

### BRIEF DESCRIPTIONS OF THE DRAWINGS

FIGS. 1 and 2 depict an example of a mask according to one embodiment of the present disclosure.

FIG. 3 depicts a view of the interior of an example of a mask according to one embodiment of the present disclosure.

FIG. 4 depicts a front view of the exterior of an example of a mask according to one embodiment of the present disclosure.

FIG. 5 depicts an example of a mask in use in an exemplary according to one embodiment of the present disclosure.

FIG. 6 depicts an example of a mask in use according to one embodiment of the present disclosure.

FIG. 7 depicts a view of the interior of an example of a mask according to one embodiment of the present disclosure.

FIG. 8 depicts an example of a nose plug according to one embodiment of the present disclosure.

FIG. 9 shows a bottom view of an example of a nose plug according to one embodiment of the present disclosure.

FIGS. 10-11 show examples of nose plugs in use according to one embodiment of the present disclosure.

FIG. 12 shows a side view of an example of a mouthpiece according to one embodiment of the present disclosure.

FIG. 13 shows a front view of an example of a mouthpiece according to one embodiment of the present disclosure.

FIGS. 14-15 depict an example of how an example of a mouthpiece may be used according to one embodiment of the present disclosure.

FIG. 16 shows a front view of an example of a nose mask and an example of a mouth mask according to one embodiment of the present disclosure.

FIG. 17A depicts an example of a nose mask and an example of a mouth mask according to one embodiment of the present disclosure.

FIGS. 17B-17C depict an example of how a nose mask and an example of how a mouth mask may be used according to one embodiment of the present disclosure.

### DETAILED DESCRIPTION

With reference to the Figures, where like elements have been given like numerical designations to facilitate an understanding of the drawings, the various embodiments of apparatus and systems of optimizing the production and consumption of nitric oxide by subjects, while facilitating efficient breathing to sustain each subject's regular activity levels, are described. The Figures are not drawn to scale.

The following description is provided as an enabling teaching of a representative set of examples. Many changes can be made to the embodiments described herein while still obtaining beneficial results. Some of the desired benefits discussed below can be obtained by selecting some of the features or steps discussed herein without utilizing other features or steps. Accordingly, many modifications and adaptations, as well as subsets of the features and steps described herein are possible and can even be desirable in certain circumstances. Thus, the following description is provided as illustrative and is not limiting.

This description of illustrative embodiments is intended to be read in connection with the accompanying Figures, which are to be considered part of the entire written description. In the description of embodiments disclosed herein, any reference to direction or orientation is merely intended for convenience of description and is not intended in any way to limit the scope of the present disclosure. Relative terms such as “lower,” “upper,” “horizontal,” “vertical,” “above,” “below,” “up,” “down,” “top” and “bottom” as well as derivative thereof (e.g., “horizontally,” “downwardly,” “upwardly,” etc.) should be construed to refer to the orientation as then described or as shown in the drawing under discussion. These relative terms are for convenience of description only and do not require that the apparatus be constructed or operated in a particular orientation. Terms such as “attached,” “affixed,” “connected” and “interconnected,” refer to a relationship wherein structures are secured or attached to one another either directly or indirectly through intervening structures, as well as both movable or rigid attachments or relationships, unless expressly described otherwise. The term “adjacent” as used herein to describe the relationship between structures/components includes both direct contact between the respective structures/components referenced and the presence of other intervening structures/components between respective structures/components.

As used herein, use of a singular article such as “a,” “an” and “the” is not intended to exclude pluralities of the article's object unless the context clearly and unambiguously dictates otherwise.

Apparatus and systems for optimizing nitric oxide production and consumption by subjects (e.g., humans), while facilitating efficient breathing to sustain each subject's regular activity levels, are provided. This disclosure may be embodied in many different forms. Exemplary embodiments are shown in the drawings and will herein be described in detail with the understanding that these embodiments are provided as an exemplification of the disclosed principles, not limitations of the broad aspects of the disclosure.

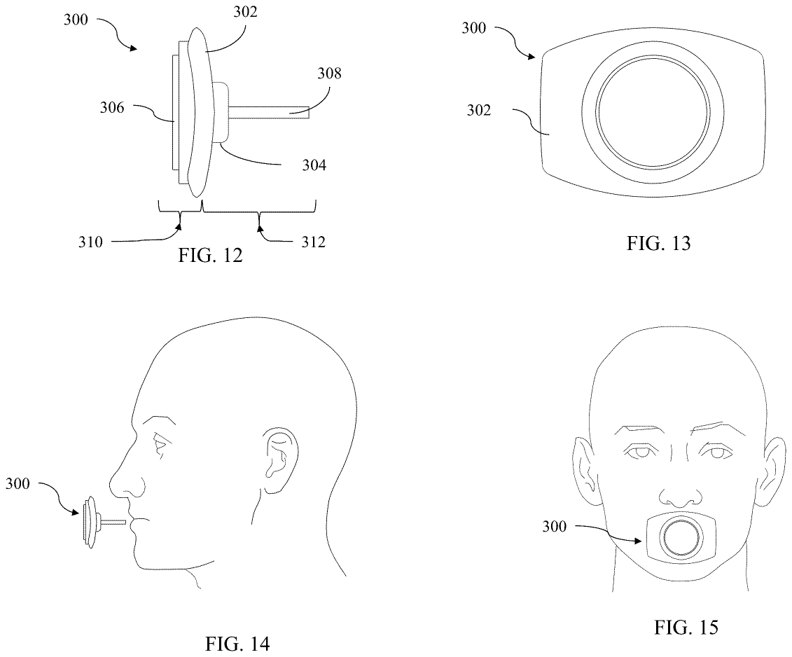

In exemplary embodiments shown in FIG. 12, an example of a mask (100a) for optimizing nitric oxide production and consumption by a subject is provided. In some embodiments, mask 100a includes a nose portion 102 (e.g., in FIG. 3). A nose portion 102 may have a curved top end that is designed to fit over a subject's (e.g., a human's) nose. A nose portion 102 may also have a seal 116 configured to seal against a subject's nose, cheeks, and upper lip. In some embodiments, nose portion 102 may have a divider 106 that is designed to abut a portion of a subject's upper lip and seal below a subject's nose. In some embodiments, seal 116 and divider 106 of nose portion 102 of mask 100a comprise a seal rim (e.g., a skirt) configured to form a hermetic seal around a subject's nose, against the subject's cheeks and abutting the subject's upper lip, creating an airtight chamber. In some embodiments, seal 116 and divider 106 are integral components of a seal rim of nose portion 102. In some embodiments, seal 116 and divider 106 are each made of a durable, flexible material (e.g., silicone, natural rubber, Ethylene Propylene Diene Monomer (EPDM), neoprene, etc.) configured to reduce pressure in any one particular spot on the subject when nose portion 102 is deployed over a subject's nose, while also configured to provide an airtight seal for nose portion 102, once nose portion 102 of mask 100a is deployed over a subject's nose. In some embodiments, seal 116 and divider 106 are configured to, once nose portion 102 of mask 100a is deployed over a subject's nose and during operation, prevent air from the surrounding (ambient) environment from leaking through the seal rim and into nose portion 102 and to prevent air within nose portion 102 from leaking through the seal rim and both out into the surrounding (ambient) environment, and out into any other portion of mask 100a (outside of nose portion 102). In some embodiments, seal 116 may be constructed such as to perform the functions of divider 106 by creating a seal all around a subject's nose, hermetically separating the nose portion 102 from a mouth portion 104 of mask 100a (see FIG. 3) without the use of a separate divider 106.

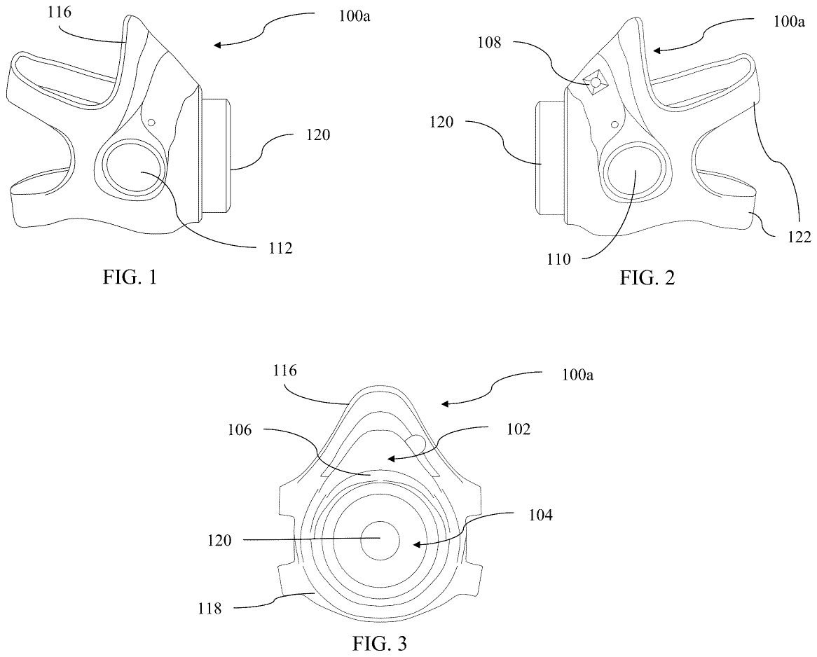

As shown in the example depicted in FIG. 2, nose portion 102 of mask 100a may have a valve 110. Valve 110 may be a flapper valve, a ball check valve, diaphragm valve, poppet valve, duckbill valve, or any other suitable mechanism configured to allow the flow of air in a single direction. In some embodiments, valve 110 is configured within nose portion 102 such that air (e.g., from the surrounding (ambient) environment) may enter through valve 110 into nose portion 102, such as during a subject's inhalation of breath through the subject's nose over which nose portion 102 is deployed. During a subject's exhalation of breath from the subject's nose, valve 110 may seal and prevent air from flowing out of nose portion 102 (e.g., out into the surrounding (ambient) environment, out into any other portion of mask 100a (outside of nose portion 102), etc.). As may be seen in the example depicted in FIG. 1, a mask 100a may include a second valve 112 that is configured, as described above for valve 110, to allow additional airflow into nose portion 102 through valve 112, while also sealing and preventing air from flowing out of nose portion 102 (e.g., out into the surrounding (ambient) environment, out into any other portion of mask 100a (outside of nose portion 102), etc.). In some embodiments, first valve 110 is configured to permit air to flow therethrough and into a first one of a subject's nostrils (and to seal to prevent air within the first nostril from flowing out and through valve 110) and second valve 112 is configured to permit air to flow therethrough and into a second one of a subject's nostrils (and to seal to prevent air within the second nostril from flowing out and through valve 112). In some embodiments, seal 116, divider 106, and valve(s) 110 (112) of nose portion 102 of mask 100a are collectively configured to prevent air from the surrounding (ambient) environment from passing into nose portion 102 except through valve(s) 110(112 ), and are also collectively configured to prevent air within nose portion 102 from flowing both out into the surrounding (ambient) environment and out into any other portion of mask 100a (outside of nose portion 102), including by preventing air within nose portion 102 from flowing through, and out of, valve(s) 110 (112) and from leaking out through seal 116 and/or divider 106.

In some embodiments, nose portion 102 of mask 100a includes a vibrating device 108. Vibrating device 108 may be, for example, a sonic oscillator (e.g., a device which generates vibrations using acoustic energy), an eccentric rotating mass motor, a linear resonant actuator, a piezoelectric vibrator, an electrodynamic shaker, and/or any other suitable device configured to create a vibration. In some embodiments, a vibrating device 108 may be configured to produce and/or simulate vibrations and/or sound of similar fundamental frequency, harmonic structure, amplitude, smoothness, and/or other characteristics of vibrations produced by a subject humming. Humming may be described as a continuous, low-frequency vocal sound produced with closed lips and vibrating vocal folds, generating a resonant tone sustained primarily through nasal airflow. The characteristics of the vibrations and/or sound waves produced by humming and/or a vibrating device 108 may facilitate and/or increase nitric oxide production in the paranasal sinuses. In some embodiments, a vibrating device 108 may be located on mask 100a such that it primarily vibrates a subject's nose (e.g., vibrates one or more nasal passages of a subject's nose). In some embodiments, a vibrating device 108 may be located on nose portion 102 such that it primarily vibrates the air going into a subject's nose (e.g., air passing through valve 110 and into nose portion 102). In certain embodiments, a vibrating device 108 may be located on nose portion 102 such that it vibrates both a subject's nose and the air going into a subject's nose. In some embodiments, a vibrating device 108 may be located on various other portions of mask 100a, such that it primarily vibrates a subject's nose, primarily vibrates the air going into a subject's nose, and/or vibrates both a subject's nose and the air going into a subject's nose.

In various embodiments, such as the example depicted in FIG. 3, mask 100a may include a mouth portion 104. In some embodiments, mouth portion 104 may include a seal 118 that is configured to seal against a subject's cheeks, chin and upper lip. In some embodiments, mouth portion 104 may include a seal 118 that is configured to seal against a subject's cheeks, and upper and lower lips. In some embodiments, mouth portion 104 may also include a divider 106 that is designed to abut a portion of a subject's upper lip and seal below a nose of a subject, such that, with the combination of seal 118 and divider 106, a mouth of the subject, once mouth portion 104 is deployed over the subject's mouth, is surrounded by a seal. In some embodiments, seal 118 and divider 106 of mouth portion 104 of mask 100a comprise a seal rim (e.g., a skirt) configured to seal mouth portion 104 all around a subject's mouth, against the subject's cheeks and chin (or lower lip) and abutting the subject's upper lip. In some embodiments, seal 118 and divider 106 are integral components of a seal rim of mouth portion 104. In some embodiments, seal 118 may be constructed such as to perform the functions of divider 106 by creating a seal all around a subject's mouth, hermetically separating the nose portion 102 from the mouth portion 104 without the use of a separate divider 106. In some embodiments, seal 118 and divider 106 are each made of a durable, flexible material (e.g., silicone, natural rubber, EPDM, neoprene, etc.) configured to reduce pressure in any one particular spot when mouth portion 104 is deployed over a subject's mouth, while also configured to provide an airtight seal for mouth portion 104, once mouth portion 104 of mask 100a is deployed over a subject's mouth. In some embodiments, seal 118 and divider 106 are configured to, once mouth portion 104 of mask 100a is deployed over a subject's mouth and during operation, prevent air from the surrounding (ambient) environment from leaking through the seal and into mouth portion 104 and to prevent air within mouth portion 104 from leaking through the seal and both out into the surrounding (ambient) environment, and out into any other portion of mask 100a (e.g., outside of mouth portion 104, into nose potion 102, etc.).

In some embodiments, mask 100a comprises a divider 106, which may be an integral divider 106 of both mouth portion 104 and nose portion 102, and which is configured to, once nose portion 102 and mouth portion 104 of mask 100a are respectively deployed over a subject's nose and mouth, prevent air within nose portion 102 from leaking into mouth portion 104 and prevent air within mouth portion 104 from leaking into nose portion 102. In some embodiments, seal 118, divider 106, and seal 116 are integral components of a seal rim of mouth portion 104 and nose portion 102 of mask 100a, which is configured to, once mouth portion 104 and nose portion 102 of mask 100a are respectively deployed over a subject's mouth and nose and during operation, provide respective airtight seals for mouth portion 104 and nose portion 102.

In some embodiments, divider 106 extends between two points on seal 118 and/or seal 116, creating a unified sealing surface. Divider 106 may be configured so as to be removable, retrofittable, and/or integral to mask 100a. In some embodiments, divider 106 may be configured to partition a mask 100a into two hermetically separate chambers, in which case seal 116 and seal 118 may be different areas of one continuous sealing surface onto which divider 106 is attached. Although not shown, other embodiments may be configured such that seal 116 and/or seal 118 alone perform the functions of divider 106 by creating a seal all around a subject's mouth and/or nose together or separately, hermetically separating the nose portion 102 from the mouth portion 104 without the use of a separate divider 106. In these embodiments, divider 106 may not perform a sealing function, and if comprising a component of mask 100a, serve as a structural member onto which seal 118 and seal 116 are attached. In these embodiments, seal 116 and seal 118 may be different areas of the same continuous sealing surface, or two separate sealing surfaces. Not all possible configurations of divider 106, seal 116, and seal 118 are shown, but any combination of these components may form airtight seals around a subject's mouth and nose, respectively, hermetically separating the nose portion 102 from the mouth portion 104.

As shown in exemplary embodiments depicted in FIGS. 1-3, mouth portion 104 of mask 100a may include a valve 120. Valve 120 may be a flapper valve, a ball check valve, diaphragm valve, poppet valve, duckbill valve, or any other suitable mechanism configured to allow the flow of air in a single direction. In some embodiments, a valve 120 is configured within mouth portion 104 such that air (e.g., from a subject's mouth) may exit through valve 120 out of mouth portion 104, such as during an exhalation of breath from a subject's mouth over which mouth portion 104 is deployed. In some embodiments, a valve 120 may seal and prevent air (e.g., air in the surrounding (ambient) environment) from flowing into mouth portion 104, such as during an inhalation of breath by a subject and through and into the subject's mouth. In some embodiments, seal 118, divider 106, and valve 120 of mouth portion 104 of mask 100a are collectively configured to prevent air within mouth portion 104 from exiting out of mouth portion 104 except through valve 120, including by preventing air within mouth portion 104 from leaking out through seal 118 and/or divider 106, and are also collectively configured to prevent air (e.g., from the surrounding (ambient) environment, from any other portion of mask 100a (e.g., from within nose portion 102)) from flowing into mouth portion 104, including by preventing air from flowing into and through valve 120 and from leaking in through seal 116 and/or divider 106. In some embodiments, seal 118, divider 106, and valve 120 of mouth portion 104 of mask 100a are collectively configured to prevent air (e.g., from the surrounding (ambient) environment, from any other portion of mask 100a (e.g., from within nose portion 102)) from flowing into mouth portion 104, including by preventing air from flowing into and through valve 120 and from leaking in through seal 116 and/or divider 106, are collectively configured to prevent air within mouth portion 104 from leaking into another portion of mask 100a (e.g., leaking into nose portion 102), and are collectively configured to permit air within mouth portion 104 to exit through valve 120 (while minimizing leakage of air within mouth portion 104 to the surrounding (ambient) environment through seal 118).

In some embodiments, such as the examples shown in FIGS. 1-3, a mask 100a has a nose portion 102 and a mouth portion 104. Nose portion 102 may be separate from mouth portion 104. As shown in the example depicted in FIG. 3, in some embodiments, mask 100a may have a divider 106 that separates and seals nose portion 102 from mouth portion 104. In some embodiments, divider 106 may be formed from silicone, or another suitable material. As shown in the example depicted in FIG. 3, divider 106 may create an airtight barrier between nose portion 102 and mouth portion 104. In some embodiments, seal 116 of nose portion 102, seal 118 of mouth portion 104, and divider 106 are configured to prevent air from being exchanged between the nose portion 102 and the mouth portion 104 of mask 100a.

In some embodiments, such as the example depicted in FIG. 2, mask 100a may have one or more adjustable straps 122 that are configured to be adjustably tightened to attach and/or secure mask 100a to a subject's face, such as by wrapping behind a subject's head and/or ears. Straps 122 may be adjustably tightened and/or configured to be loosened to remove mask 100a from the subject's face; for example, straps 122 may include buckles, snaps, toggles, magnets, and/or buttons which allow tightness adjustments. In some embodiments, mask 100a may be detachably connected and/or secured to straps 122, for example as by buckles, snaps, toggles, magnets, and/or buttons. In some embodiments, mask 100a may be connected to using the mechanisms which enable connection to straps 122. For example, mask 100a may be connectable to a hood worn on a subject's head, and/or mask 100a may be employed by resting on a subject's face, held in place by gravity.

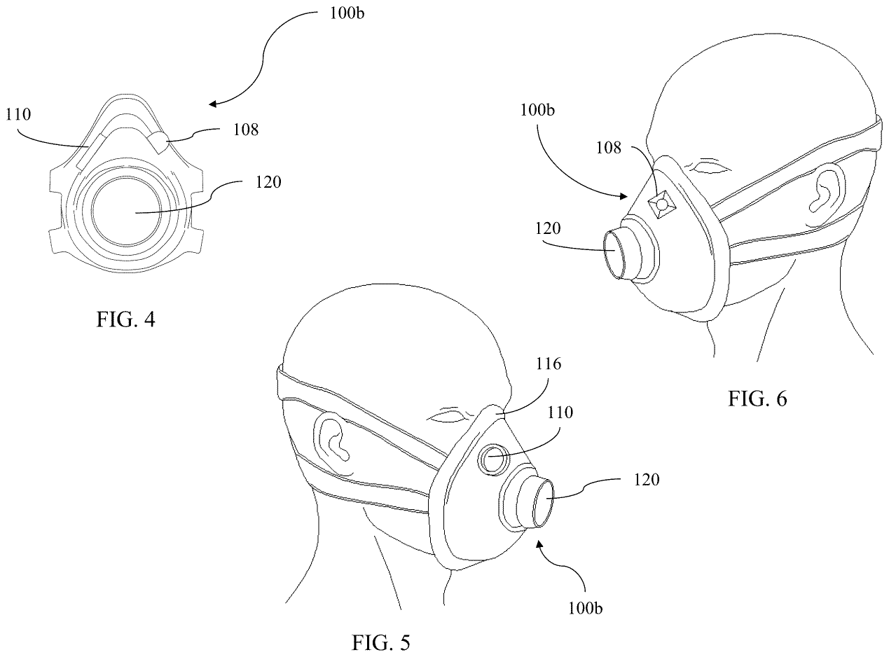

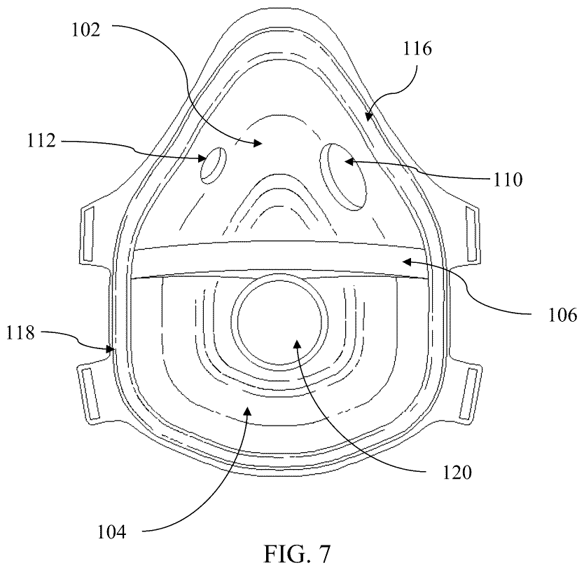

In exemplary embodiments shown in FIGS. 4-7, a mask 100b is shown. FIG. 4 illustrates a front view of an example of a mask 100b, having a valve 110, valve 120, and vibrating device 108. In some embodiments, mask 100b has a nose portion (e.g., 102) and a mouth portion (e.g., 104) as described above. Mask 100b may have a seal 116 around a rim that is configured to rest against a subject's face. In some embodiments, seal 116 and divider 106 of mouth portion 104 of mask 100b comprise a seal rim (e.g., a skirt) configured to seal mouth portion 104 all around a subject's mouth, against the subject's cheeks and chin (or lower lip) and abutting the subject's upper lip. In some embodiments, seal 116 and divider 106 are integral components of a seal rim of mouth portion 104. In some embodiments, seal 116 may be configured such as to perform the functions of divider 106 by creating a seal all around a subject's mouth, hermetically separating the nose portion 102 from the mouth portion 104 without the use of a separate divider 106. As shown in the examples depicted in FIGS. 5 and 6, in some embodiments, mask 100b may be affixed to a subject's face and may be configured (such as described in the examples above) to allow air to flow into, but not out of, a nose portion (e.g., 102) and out of, but not into, a mouth portion (e.g., 104) of mask 100b. In FIG. 7, one embodiment of mask 100b is shown from the rear perspective, with divider 106 hermetically separating the nose portion 102 from the mouth portion 104. In this embodiment, divider 106 extends between two points on seal 118 and/or seal 116, creating a unified sealing surface. Divider 106 may be configured so as to be removable, retrofittable to existing masks, and/or integral to mask 100b. In some embodiments, divider 106 may be configured to partition a mask 100b into two hermetically separate chambers, in which case seal 116 and seal 118 may be different areas of one continuous sealing surface onto which divider 106 is attached. Although not shown, other embodiments may be configured such that seal 116 and/or seal 118 alone perform the functions of divider 106 by creating a seal all around a subject's mouth and/or nose together or separately, hermetically separating the nose portion 102 from the mouth portion 104 without the use of a separate divider 106. In these embodiments, divider 106 may not perform a sealing function, and if comprising a component of mask 100b, serve as a structural member onto which seal 118 and seal 116 are attached. In these embodiments, seal 116 and seal 118 may be different areas of the same continuous sealing surface, or two separate sealing surfaces. Not all possible configurations of divider 106, seal 116, and seal 118 are shown, but any combination of these components may form airtight seals around a subject's mouth and nose, respectively, hermetically separating the nose portion 102 from the mouth portion 104

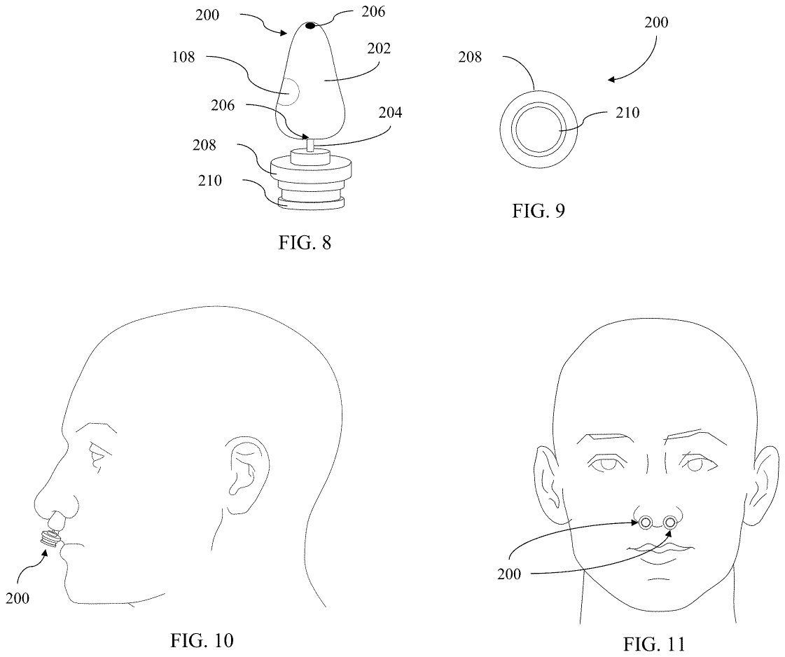

In some embodiments, such as the examples shown in FIGS. 8-9, a nose plug 200 is provided. In various embodiments, nose plug 200 includes a nose insert 202 that is designed to fit within a subject's nostril. In some embodiments, nose plug 200 is provided with a vibrating device 108, which as described, may be configured to produce a sound and/or vibration similar to humming. Vibrating device 108 may be located anywhere on nose plug 200 such that it primarily vibrates a subject's nose (e.g., vibrates one or more nasal passages of a subject's nose). In some embodiments, a system or apparatus would include a plurality of nose plugs 200, where the respective nose insert 202 of each nose plug 200 is designed to fit within a respective nostril of a subject. In some embodiments, such as the examples shown in FIGS. 8-9, nose insert 202 may have a tapered cylindrical shape. Nose insert 202 may be made of a durable, flexible material (e.g., silicone, foam, natural rubber, EPDM, neoprene, etc.) configured to reduce pressure in any one particular spot on the subject when nose insert 202 is deployed in a subject's nose, while also configured to provide an airtight seal. That shape and/or material of nose insert 202 may also be configured such that the friction between nose insert 202 and the subject's nasal passage walls is sufficient to maintain the nose insert 202 adequately inserted as to provide and maintain an airtight seal while subject is positioned such that the nose insert 202 would otherwise become loose due to gravity and/or motion of the subject. That shape and/or material of nose insert 202 may also be configured such that a subject is able to insert and remove nose insert 202 from a nostril without aid from instruments and/or other subjects.

In some embodiments, nose insert 202 may have hole(s) 206 at a top and/or bottom portion. Hole(s) 206 may be open and sufficiently sized as to permit airflow approximately equivalent to that drawn through an unobstructed nostril of a subject during inhalation. In some embodiments, such as the example shown in FIG. 8, nose plug 200 may have a tube 204 that may, in some embodiments, be a shape that permits airflow through nose plug 200 approximately equivalent to that drawn through an unobstructed nostril of a subject during inhalation, such as a hollow cylinder. In some embodiments, tube 204 may be coupled to nose insert 202 such that a top end of tube 204 abuts hole(s) 206, and that hole(s) 206 surrounds a hollow portion of tube 204. Hole(s) 206 and tube 204 may be configured in any way such as to allow air to flow and/or pass internally through the entire length of nose insert 202. For example, tube 204 may be a hollow plastic cylinder extending throughout the length of nose insert 202 and extending to and/or protruding beyond hole(s) 206 at one terminal end of nose insert 202, while extending to and/or protruding beyond hole(s) 206 at the opposite terminal end of nose insert 202. Tube 204 may additionally be integral to nose insert 202. Tube 204 may comprise any material suitable for constructing a structure resistant to collapse upon application of pressure to the structure's exterior, such as may occur during insertion of nose insert 202 into a subject's nostril and/or during breathing (e.g., plastic, silicone elastomer, stainless steel, etc.).

In some embodiments, a bottom end of tube 204 may be coupled with a port 208. Port 208 may have a valve 210. Valve 210 may be a flapper valve, a ball check valve, diaphragm valve, poppet valve, duckbill valve, or any other suitable mechanism configured to allow the flow of air in a single direction. In some embodiments, valve 210 may be configured to allow the flow of air into port 208, through tube 204, and out of hole 206. In some embodiments, valve 210 may be configured to prevent the flow of air from hole 206 and through tube 204 such that, when inserted into a nostril of a subject, exhaled air does not come out of port 208.

FIGS. 10 and 11 illustrate an exemplary use of example nose plug 200, such that air may be allowed into a subject's nose during inhalation and prevented from exiting the subject's nose during exhalation, according to some embodiments of the present disclosure. Collectively, the components shown in FIGS. 10 and 11 may be configured in any such arrangement as to prevent air from passing through the subject's nostrils without travelling through at least valve 210.

FIGS. 12 and 13 illustrate an example of a mouthpiece 300 in accordance with one embodiment of the present disclosure, which is configured to abut a subject's mouth. In some embodiments, mouthpiece 300 may have a seal 302. Seal 302 may be formed from a durable, flexible material (e.g., silicone, natural rubber, EPDM, neoprene, etc.) configured to reduce pressure in any one particular spot on the subject when mouthpiece 300 is deployed about and abutting a subject's lips, while also providing for an airtight seal around a subject's mouth. In some embodiments, mouthpiece 300 may have a passageway 304 such as, for example, the example depicted in FIG. 12. In some embodiments, passageway 304 may be configured in any way such as to permit airflow approximately equivalent to that passed through the unobstructed mouth of a subject during exhalation. Passageway 304 may comprise any material suitable for constructing a structure resistant to collapse upon application of pressure to the structure's exterior, such as may occur during deployment of mouthpiece 300 and/or during breathing (e.g., plastic, silicone elastomer, stainless steel, etc.). For example, passageway 304 may be configured as a plastic, hollow cylinder that passes and/or projects through seal 302 of mouthpiece 300.

In some embodiments, a tab 308 may project from passageway 304 on a rear side 312 of mouthpiece 300. Tab 308 may be integrally connected and/or detachable from mouthpiece 300, and may further be configured to abut the interior of a subject's mouth and/or teeth such that friction and/or biting force applied by a subject assists and/or maintains mouthpiece 300 abutting the subject's lips. Tab 308 may be constructed of a material such as plastic, silicone elastomer, and/or stainless steel.

In some embodiments, passageway 304 may abut and be connected to a valve 306. Valve 306 may be a flapper valve, a ball check valve, diaphragm valve, poppet valve, duckbill valve, or any other suitable mechanism configured to allow the flow of air in a single direction. In some embodiments, valve 306 may be configured to allow the flow of air from a subject's mouth, through passageway 304 towards a front end 310 of mouthpiece 300, and out of valve 306 to the surrounding environment such as to allow a subject to exhale breath via the subject's mouth. In some embodiments, valve 306 may be configured to prevent the flow of air into passageway 304 from a front end 310 of mouthpiece 300, such as to stop a subject from inhaling air via the subject's mouth (while still permitting the subject to inhale air via the subject's nose).

FIGS. 14 and 15 illustrate an exemplary use of an example mouthpiece 300 in accordance with some embodiments of the present disclosure. In some embodiments, the components shown in FIGS. 14 and 15 are collectively configured to prevent air (e.g., from passing out of a subject's mouth and into the surrounding (ambient) environment except for air flowing through at least valve 306. As shown, mouthpiece 300 may about a subject's lips and/or skin surrounding the mouth. In some embodiments, mouthpiece 300 may be coupled and/or sealed to a subject's skin using media on seal 302, such as petroleum jelly, medical-grade adhesive, and/or silicone gel.

In accordance with some embodiments of the present disclosure, a nose plug (e.g., nose plug 200) and a mouthpiece (e.g., mouthpiece 300) may be configured for use in conjunction with each other such that a nose plug (e.g., 200) is configured to be inserted into each of a subject's nostrils and mouthpiece (e.g., 300) is configured to be coupled with the subject's mouth. Nose plug (e.g., 200) and mouthpiece (e.g., 300) may be configured to operate together such that, during their combined operation, air may be inhaled in through a subject's nose but not in through the subject's mouth. Additionally, nose plug (e.g., 200) and mouthpiece (e.g., 300) may also configured to allow air to be exhaled out through a subject's mouth but not out through the subject's nose. In accordance with some embodiments of the present disclosure, such a system provides an example of a configuration that may optimize the production and absorption of nitric oxide by a subject by preventing exhalation of produced nitric oxide in the paranasal sinuses while facilitating efficient breathing to sustain regular activity levels.

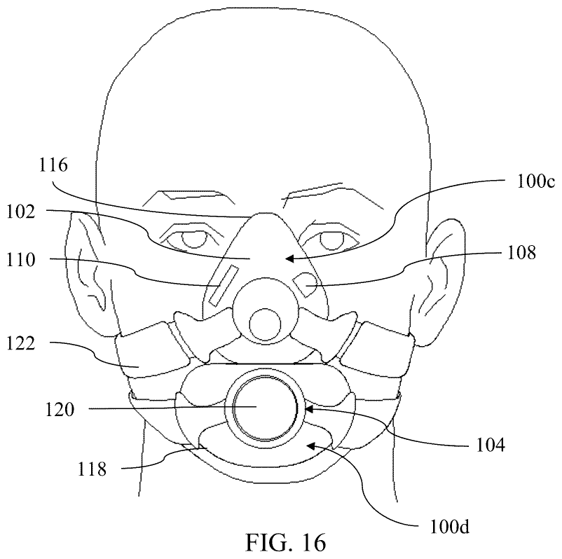

FIG. 16 illustrates one embodiment of a nose mask 100c and mouth mask 100d. Nose mask 100c comprises a nose portion 102, seal 116, valve(s) 110 (112), straps 122, and/or vibrating device 108. Nose mask 100c performs substantially the same functions as nose portion 102 shown in FIGS. 1-7. For example, once nose mask 100c is deployed over a subject's nose and during operation, seal 116 prevents air from the surrounding (ambient) environment from leaking into nose portion 102 and prevents air within nose portion 102 from leaking both out into the surrounding i(ambient) environment. In some embodiments, seal 116, valve(s) 110 (112), straps 122, and/or vibrating device 108 perform substantially the same functions as in the embodiments shown in FIGS. 1-7, descriptions of which are herein incorporated by reference. For example, seal 116 may be configured to form a hermetic seal all around a subject's nose by at least abutting the subject's cheeks and the subject's upper lip. Mouth mask 100d comprises seal 118, valve 120, and/or straps 122. Mouth mask 100d performs substantially the same functions as mouth portion 104 as shown in FIG. 1-7. In some embodiments, seal 118, valve 120, and/or straps 122 perform substantially the same functions as in the embodiments shown in FIGS. 1-7, descriptions of which are herein incorporated by reference. For example, seal 118 may comprise a seal rim (e.g., a skirt) configured to seal mouth mask 100d all around a subject's mouth, against the subject's cheeks and chin (or lower lip) and abutting the subject's upper lip.

In some embodiments, mouth mask 100d and nose mask 100c may be configured to be worn simultaneously and/or independently. In such embodiments, seal 116 and seal 118 may be designed to abut a subject's upper lip simultaneously while allowing the nose mask 100c and mouth mask 100d to remain hermetically sealed around a subject's nose and mouth, respectively. In such embodiments, mouth mask 100d and nose mask 100c may be detachably connectable, for example as by buckles, snaps, toggles, magnets, and/or buttons. Straps 122 may be additionally configured to detachably connected to mouth mask 100d and/or nose mask 100c.

In accordance with some embodiments of the present disclosure, a nose mask (e.g., nose mask 100c) and a mouth mask (e.g., mouth mask 100d) may be configured for use in conjunction with each other such that a nose mask (e.g., 100c) is configured to be deployed to create a hermetic seal around a subject's nose and mouth mask (e.g., 100d) is configured to create a hermetic seal around a subject's mouth. Nose mask (e.g., 100c) and mouth mask (e.g., 100d) may be configured to operate together such that, during their combined operation, air may be inhaled in through a subject's nose but not in through the subject's mouth. Additionally, nose mask (e.g., 100c) and mouth mask (e.g., 100d) may also be configured to allow air to be exhaled out through a subject's mouth but not out through the subject's nose.

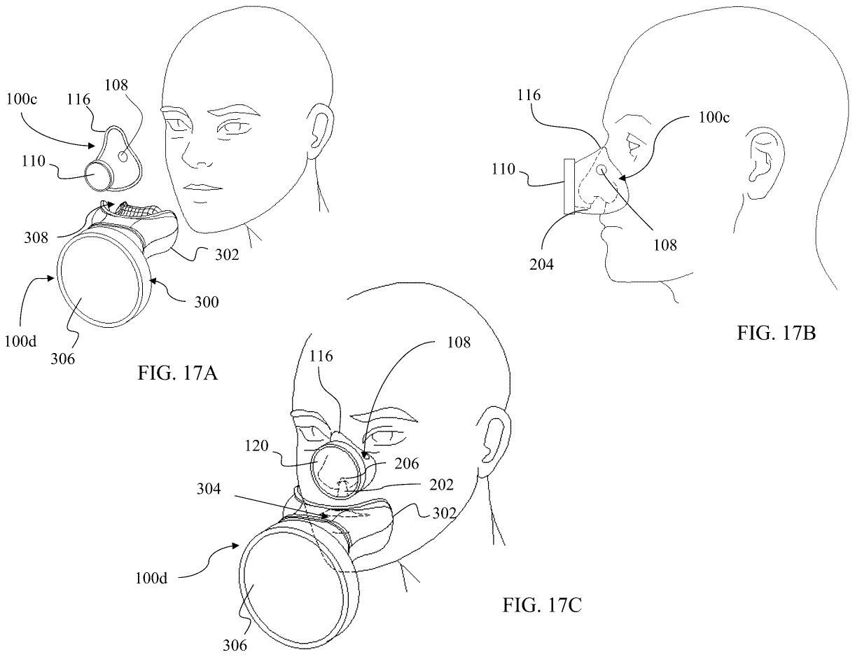

FIGS. 17A-17C show an embodiment of nose mask 100c and mouth mask 100d. In some embodiments, nose mask 100c is configured with a valve 110, seal 116, vibrating device 108, as well as a nose insert 202 being provided with hole(s) 206, tube 204, and/or port 208. The descriptions and functions of individual elements described in the context of FIGS. 1-16 are thusly incorporated herein. In the embodiments shown in FIGS. 17A-17C, port 208 is connected to valve 110. This comprises a path for air to flow from the surrounding environment, through valve 110, through tube 204, through hole(s) 206, and into a subject's nostril. Nose insert 202 may be integral to nose mask 100c, while also configured such that it may be sufficiently inserted into a subject's nose during deployment of nose mask 100c as to provide an airtight seal between the surface nose insert 202 and the interior of a subject's nostrils. Seal 116 may be configured to provide a hermetic seal against subject's face. The airtight barrier formed by a subject's nostril and nose insert 202 may prevent air from passing between the interior of a subject's nose and the chamber created by the contact of seal 116 with subject's face. Additionally, the chamber created by the contact of seal 116 with the subject's face may be hermetically sealed from the surrounding (ambient) environment. Although not shown in FIGS. 17A-17C, nose mask 100c may be retained on subject's face with sufficient pressure to create seals as described above via straps (e.g., straps 122). In other embodiments, nose mask 100c may be retained on a subject's face via friction between nose insert 202 and a subject's nostril.

Mouth mask 100d is configured with a seal 302, passageway 304, valve 306, and/or tab 308. The descriptions and functions of individual elements described in the context of FIGS. 1-16 are thusly incorporated herein. The embodiment shown in FIGS. 17A-17C further shows a passageway 304 extending continuously from a valve 306 through a tab 308. Tab 308 may include a shape configured to abut the interior of a subject's mouth and/or teeth such that friction and/or biting force applied by a subject assists and/or maintains mouthpiece 300 abutting the subject's lips. Furthermore, tab 308 may be sufficiently sized to permit passageway 304 to pass completely through tab 308, allowing air to flow from a subject's mouth, through tab 308 via passageway 304 to valve 306, and through valve 306 into the surrounding environment. Although not shown in FIGS. 17A-17C, mouth mask 100d may be retained on a subject's face with sufficient pressure to create seals as described above via straps (e.g., straps 122). In some embodiments, nose mask 100c may be retained on a subject's face by friction and/or biting force between tab 308 and surfaces inside a subject's mouth.

In some embodiments, mouth mask 100d and nose mask 100c may be configured to be worn simultaneously and/or independently. In such embodiments, seal 116 and seal 302 may be designed to abut a subject's upper lip simultaneously while allowing the nose mask 100c and mouth mask 100d to remain hermetically sealed around a subject's nose and mouth, respectively. In such embodiments, mouth mask 100d and nose mask 100c may be detachably connectable, for example as by buckles, snaps, toggles, magnets, and/or buttons. Straps 122 may be additionally configured to detachably connected to mouth mask 100d and/or nose mask 100c.

In accordance with some embodiments of the present disclosure, a nose mask (e.g., nose mask 100c) and a mouth mask (e.g., mouth mask 100d) may be configured for use in conjunction with each other such that a nose mask (e.g., 100c) is configured to be deployed to create a hermetic seal around a subject's nose and mouth mask (e.g., 100d) is configured to create a hermetic seal around a subject's mouth. Nose mask (e.g., 100c) and mouth mask (e.g., 100d) may be configured to operate together such that, during their combined operation, air may be inhaled in through a subject's nose but not in through the subject's mouth. Additionally, nose mask (e.g., 100c) and mouth mask (e.g., 100d) may also configured to allow air to be exhaled out through a subject's mouth but not out through the subject's nose.

Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination may in some cases be excised from the combination, and the claimed combination may be directed to a sub-combination or variation of a sub-combination.

While various embodiments are described herein, it is to be understood that the embodiments described are illustrative only and that the scope of the subject matter is to be accorded a full range of equivalents, many variations and modifications naturally occurring to those of skill in the art from a perusal hereof.

1. An apparatus for optimizing nitric oxide production and consumption by a subject, comprising:
a first portion configured for airtight deployment over a nose, or within the nostrils of a nose, of a subject, the first portion comprising:
a valve configured to, during operation,:
pass air from an ambient environment therethrough and into the first portion; and
prevent air within the first portion from being passed therethrough to exit the first portion;
a second portion configured for airtight deployment over a mouth of a subject, the second portion comprising:
a valve configured to, during operation,:
prevent air from being passed therethrough to enter into the second portion; and
pass air from within the second portion therethrough and out into the ambient environment;
wherein the first portion and the second portion are hermetically separate.

2. The apparatus of claim 1, further comprising:
a mask configured for deployment over a nose and a mouth of a subject; wherein the first portion and the second portion are integral portions of the mask;
the first mask portion further comprising:
a seal configured to prevent air from entering or exiting the first mask portion except through the first mask portion valve;
the second mask portion further comprising:
a seal configured to prevent air from entering or exiting the second mask portion except through the second mask portion valve; and
the mask further comprising a divider between the first mask portion and the second mask portion, the divider configured to separate the first mask portion and the second mask portion from each other;
wherein the mask divider, the first mask portion seal, and the second mask portion seal are configured to prevent air from being exchanged between the first mask portion and the second mask portion.

3. The apparatus of claim 2, wherein the mask further comprises an adjustable strap that is configured to be deployed behind a subject's head and to be tightened to secure the mask once deployed over the nose and the mouth of the subject.

4. The apparatus of claim 1, wherein the first portion further comprises a vibrating device configured to generate vibrations simulating a humming sound.

5. The apparatus of claim 4, wherein the vibrating device is positioned on the first portion such that, during operation, the vibrating device is configured to vibrate one or more nasal passages of the nose of the subject.

6. The apparatus of claim 4, wherein the vibrating device is positioned on the first portion such that, during operation, the vibrating device is configured to vibrate air entering the first portion through the first portion valve.

7. The apparatus of claim 1, wherein the first portion comprises:
a plurality of nose plugs, wherein at least a portion of each nose plug is configured for airtight deployment within a respective nostril of the nose of the subject, wherein each nose plug comprises:
a respective valve configured to, during operation,:
pass air from an ambient environment therethrough and into the respective nose plug within the respective nostril of the nose of the subject; and
prevent air within the respective nostril of the nose of the subject from being passed therethrough to exit the respective nose plug.

8. The apparatus of claim 7, wherein each nose plug further comprises:
a respective nose insert configured for airtight deployment within the respective nostril of the nose of the subject, the respective nose insert comprising a respective tube configured to permit the passage of air therethrough, wherein a first end of the respective tube is open to permit air to enter or exit the respective nose insert, and wherein a second end of the respective tube is coupled to the respective valve.

9. The apparatus of claim 7, wherein the second portion further comprises:
a mouthpiece configured for airtight deployment over the mouth of the subject, the mouthpiece comprising:
the second portion valve; and
a seal configured to prevent air from entering or exiting the mouthpiece except through the second portion valve.

10. The apparatus of claim 9, wherein the mouthpiece further comprises a respective tube configured to permit the passage of air therethrough, wherein a first end of the mouthpiece tube is coupled to the second portion valve, and wherein a second end of the mouthpiece tube is open to permit air to enter or exit the mouthpiece tube.

11. An apparatus for optimizing nitric oxide production and consumption by a subject, comprising:
a mask configured for deployment over a nose and a mouth of a subject, the mask comprising:
a first mask portion configured for airtight deployment over the nose of the subject, the first mask portion comprising:
a valve configured to, during operation,:
pass air from an ambient environment therethrough and into the first mask portion; and
prevent air within the first mask portion from being passed therethrough to exit the first mask portion; and
a seal configured to prevent air from entering or exiting the first mask portion except through the first mask portion valve;
a second mask portion configured for airtight deployment over the mouth of the subject, the second mask portion comprising:
a valve configured to, during operation,:
prevent air from being passed therethrough to enter into the second mask portion; and
pass air from within the second mask portion therethrough and out into the ambient environment; and
a seal configured to prevent air from entering or exiting the second mask portion except through the second mask portion valve;
wherein the first mask portion and the second mask portion are hermetically separate.

12. The apparatus of claim 11, wherein the mask further comprises:
a divider between the first mask portion and the second mask portion, the divider configured to separate the first mask portion and the second mask portion from each other;
wherein the mask divider, the first mask portion seal, and the second mask portion seal are configured to prevent air from being exchanged between the first mask portion and the second mask portion.

13. The apparatus of claim 11, wherein the mask further comprises an adjustable strap that is configured to be deployed behind a subject's head and to be tightened to secure the mask once deployed over the nose and the mouth of the subject.

14. The apparatus of claim 11, wherein the first mask portion further comprises a vibrating device configured to generate vibrations simulating a humming sound.

15. The apparatus of claim 14, wherein the vibrating device is positioned on the first mask portion such that, during operation, the vibrating device is configured to vibrate one or more nasal passages of the nose of the subject.

16. A system for optimizing nitric oxide production and consumption by a subject, comprising:
a plurality of nose plugs, wherein at least a portion of each nose plug is configured for airtight deployment within a respective nostril of the nose of the subject, wherein each nose plug comprises:
a respective valve configured to, during operation,:
pass air from an ambient environment therethrough and into the respective nose plug within the respective nostril of the nose of the subject; and
prevent air within the respective nostril of the nose of the subject from being passed therethrough to exit the respective nose plug;
a mouthpiece configured for airtight deployment over the mouth of the subject, the mouthpiece comprising:
a valve configured to, during operation,:
prevent air from being passed therethrough to enter into the mouthpiece; and
pass air from within the mouth of the subject therethrough and out into the ambient environment;
a seal configured to prevent air from entering or exiting the mouthpiece except through the mouthpiece valve;
wherein the plurality of nose plugs and the mouthpiece are hermetically separate.

17. The system of claim 16, wherein each nose plug further comprises:
a respective nose insert configured for airtight deployment within the respective nostril of the nose of the subject, the respective nose insert comprising a respective tube configured to permit the passage of air therethrough, wherein a first end of the respective tube is open to permit air to enter or exit the respective nose insert, and wherein a second end of the respective tube is coupled to the respective nose plug valve.

18. The system of claim 16, wherein the mouthpiece further comprises a respective tube configured to permit the passage of air therethrough, wherein a first end of the mouthpiece tube is coupled to the mouthpiece valve, and wherein a second end of the mouthpiece tube is open to permit air to enter or exit the mouthpiece tube.

19. The system of claim 16, wherein at least one of the plurality of nose plugs comprises a vibrating device configured to generate vibrations simulating a humming sound.

20. The system of claim 19, wherein the vibrating device is positioned on the at least one nose plug such that, during operation, the vibrating device is configured to vibrate one or more nasal passages of the respective nostril of the nose of the subject.
